(19) United States
(12) Patent Application Publication
(10) Pub. No.: US 2011/0135868 A1
(43) Pub. Date: Jun. 9, 2011

(54) SECTION REINFORCEMENT FOR SANDWICH STRUCTURES

(75) Inventors: Gregor Christian Endres, Pfaffenhofen (DE); Hans-Jurgen Weber, Verden (DE)

(73) Assignee: AIRBUS OPERATIONS GMBH, Hamburg (DE)

(21) Appl. No.: 12/991,951

(22) PCT Filed: Mar. 24, 2009
(86) PCT No.: PCT/EP2009/053414

§ 371 Date: Feb. 11, 2011

(30) Foreign Application Priority Data
May 16, 2008 (DE) 10 2008 001 826.0

(51) Int. Cl. B29C 70/24; D05B 97/00

(52) U.S. Cl. 428/67; 112/475.08

(57) ABSTRACT

To form a cutout reinforcement according to the invention for a sandwich construction, according to the invention two methods are combined to improve the strength characteristics of a braid core which preferably consists of foamed material. For this purpose, a braiding is combined with fibre bundles which are pulled through holes in the braid core. As a result, the cutout reinforcement according to the invention for a sandwich construction has particularly outstanding strength characteristics, while the component has only a low weight.

### CROSS-REFERENCE TO RELATED APPLICATIONS

This application claims the benefit of U.S. Provisional Application No. 61/127,850, filed May 16, 2008 and German Patent Application No. 10 2008 001 826.0, filed May 16, 2008, the entire disclosures of which are herein incorporated by reference.

### FIELD OF THE INVENTION

The present invention relates to a cutout reinforcement for sandwich constructions.

Due to their particularly good ratio of rigidity or strength to density, sandwich constructions have a wide range of applications, particularly in the field of aircraft construction.

Sandwich constructions are generally formed from an upper and a lower cover layer or face sheet, between which, to increase the rigidity, a honeycomb-like core structure which is formed from vertically extending cells having a hexagonal cross section, for example, is located.

Rigid foamed materials are a commercially available alternative to honeycomb structures. They have advantages over honeycomb structures, inter alia in the area of thermal and acoustic insulation, and in the process technology for the production of sandwich constructions. A disadvantage of these foam structures is seen in the lower mechanical strength values compared to honeycombs of a comparable density. To compensate for these relatively poor mechanical strength values, the literature discloses, inter alia, various sewing approaches, some of which also describe commercially available products. The sewing technique provides the opportunity of introducing fibres and threads at different angles and via a component of varying density. The stitch speeds which are technically possible allow the component to be sewn in a rapid manner. Following a resin infiltration process, the pierced regions contribute significantly to the mechanical reinforcement of the basic foamed material. The advantages here reside in the processing speed and in the possibility of mechanically adapting the core structure to the respective application. These structures are already used in sandwich constructions for lorry manufacture and shipbuilding.

The sewing methods used here have in common the fact that the needle pierces the foamed material and, in so doing, simultaneously introduces the thread or fibres. The differences between the individual methods reside in the fixing of the thread. In the tufting method, a loop which is fixed, for example, in a silicone rubber is formed on the lower side. Alternatively, other methods work using an under-thread or, as in blind stitch, a one-sided chain stitch is used.

The major disadvantage of these methods is that, after the needle has been withdrawn, the remaining hole is sometimes much too large relative to the amount of fibres which has been introduced (i.e. the needle diameter always determines the size of the hole). After infiltration, the cavity is filled with resin. Therefore, the improvement in the mechanical characteristics is based mainly on the resin which is introduced. The resulting core structure has a greatly increased weight as a result of this.

The increase in weight in relation to the improvement in the mechanical characteristics is too great for use in aircraft construction. Therefore, a use of sandwich constructions with core structures of this type is not considered.

DE 10 2005 024 408 A1 discloses a method for reinforcing foamed materials using fibres or fibre bundles, which method allows the production of a composite material in which the introduced fibres are substantially responsible for the improvement in the mechanical characteristics of the foam core. This document describes both the method for reinforcing the foamed materials and a reinforced sandwich construction. In the method, a foamed material is provided with bundles of fibres which are introduced therein using a needle. In this method, the needle initially makes a through hole in the foamed material from one side in order to then pick up a fibre bundles located on the other side and pull it into the foamed material.

DE 10 2004 017 311 A1 discloses a method for producing fibre composite semi-finished products by the circular braiding method, in which a braid core is braided with braiding threads.

In components used in aircraft, there are numerous regions in which openings have to be introduced into a sandwich construction. The resulting cut edges must be subsequently re-sealed and it must be ensured that no instability arises on the periphery of the sandwich construction. This applies to all sandwich constructions without exception. It is precisely in the case of heavily loaded cutouts, for example window apertures, that this can lead to problems.

### SUMMARY OF THE INVENTION

Therefore, the object of the present invention is to provide a method in which an opening can be provided even during production of the component, such that very stable cutouts are produced, with a low component weight.

This object is achieved according to the invention by the features of the respective independent claims. Advantageous embodiments and improvements of the invention are set out in the subclaims.

In a method according to the invention for the production of a cutout reinforcement for a sandwich construction by a circular braiding method, an annular braid core is braided with strands of fibres and, before or after braiding, through holes are produced in the braid core and one or more bundles of fibres are pulled into the through holes in the braid core by a needle.

The fibre bundle is preferably hooked into the needle at least temporarily when it is pulled into the through holes. Hooking the fibre bundle into the needle affords the advantage that a threading operation for joining the needle to the fibre bundle is not required. Consequently, the fibre bundle can be attached in a faster and easier manner to the needle. Furthermore, joining by hooking-in can be automated more easily. In this way, it is possible to advantageously also use a plurality of individual fibre bundles.

According to a preferred embodiment of the invention, when the fibre bundle is pulled in, the needle is substantially loaded in tension in an axial direction outside a hook. The fibre bundle is thus not pushed by the needle into the braid core, but is pulled by the hook. Consequently, during the pulling-in procedure in the region of a through hole, it is unnecessary to squeeze the fibre bundle into the through hole in addition to the needle, which would result in a undesirable widening of the through hole. Preferably only in the region of the hook is there also a fibre bundle in the through hole.

In a further preferred embodiment, a foamed material braid core is braided. Foamed material has advantages over the widely used honeycomb structures, inter alia in thermal and acoustic insulation, and in the process technology for the production of sandwich constructions.

According to a preferred embodiment, before braiding, at least one cover layer which has a higher rigidity than the braid core is applied to the braid core. The cover layer makes it possible to increase the outer strength of the cutout reinforcement for a sandwich construction.

In a further embodiment, the braid core is braided several times in succession. In this respect, individual non-wavy reinforcing fibre layers are preferably laid in each case on the braid core. This has the advantage that the calculability of the cutout reinforcement produced according to the invention is improved, since mathematical calculation approaches can be applied to unidirectional fabrics.

According to a further embodiment, the needle also makes the through hole. Thus, using the needle as the tool, the through hole is produced and the fibre bundle is also pulled into the braid core. This has the advantage that only one tool is required for both operations. This means that time can be saved, since it is unnecessary to change tools between the operations. Furthermore, this is particularly economical, because only one tool with the associated mechanism and control system is required as far as the machine is concerned.

In a further preferred embodiment, shortly before or during the braiding procedure, an adhesive which has not yet cured during the braiding procedure is applied to the braid core or to the fibre strand. The adhesive bonds the fibre strands to the braid core and the fibre bundles. The strength of the braiding is thereby increased. Furthermore, an improved stability of the braiding is produced in cases where parts of the braiding are damaged, for example by mechanical or thermal influences.

According to a further preferred embodiment, after the fibre bundles have been pulled into the through holes, said through holes and/or the braid core are infiltrated by a curable plastics material. This measure improves the bond between the individual fibres and the braid core which preferably consists of foamed material. Any known infiltration method can be used for this procedure.

According to a further preferred embodiment, in one step of the method the fibre strands and the fibre bundles are joined together in that they react chemically with one another. This concerns the points at which the fibre strands and the fibre bundles extend over one another, i.e. cross one another. The joining or adhesive bonding of the fibre strands to the fibre bundles at the crossing points further increases the strength of the entire composite structure consisting of braid core and fibres. The bonding is particularly preferably mechanically activated by contact pressure between fibres, preferably by the effect of heat or by radiation with light. Of course, any other method can also be used for activating an adhesive bond of this type. The fibre strands and the fibre bundles can have the same adhesive. It is preferable for the fibre strands and the fibre bundles to have different components of a multi-component adhesive which then inter-react and initiate adhesion. A third additional chemical substance is preferably provided which initiates the adhesion procedure.

A cutout reinforcement according to the invention for a sandwich construction has an annular braid core, a braiding of the braid core and at least one through hole through the annular braid core and at least one fibre bundles arranged in the through hole, the through hole having a cross-sectional area which is substantially completely filled by the at least one fibre bundle and the braiding also extending in an inner region of the annular braid core.

According to the invention, two methods are combined to improve the strength characteristics of a braid core which preferably consists of foamed material, so that the cutout reinforcement according to the invention is formed for a sandwich construction. For this purpose, a braiding is combined with fibre bundles which are pulled through the braid core, according to a sink-stitching. As a result, the cutout reinforcement according to the invention for a sandwich construction has particularly outstanding strength characteristics while the component has only a low weight.

According to a preferred embodiment, the at least one fibre bundle has at least one loop. The loop makes it possible for the fibre bundle to be pulled into the through holes in the braid core by a hook.

### BRIEF DESCRIPTION OF THE DRAWINGS

In the following, the invention will be described in more detail on the basis of embodiments with reference to the accompanying figures of the drawings, in which

FIG. 1 is a schematic cross-sectional view of a cutout reinforcement according to the invention for a sandwich construction according to a preferred embodiment of the invention;

FIG. 2 is a schematic cross-sectional view of a stage of the method in which the needle has passed through the braid core and, when pulled back, will pull fibre bundles into the braid core;

FIG. 3 is a schematic cross-sectional view of a braid core in the braiding step of the method;

FIG. 4 is a cross-sectional view of a detail of a braid core provided with cover layers.

### DESCRIPTION OF EXEMPLARY EMBODIMENTS

In the figures, like reference numerals denote like or functionally identical components, unless indicated otherwise.

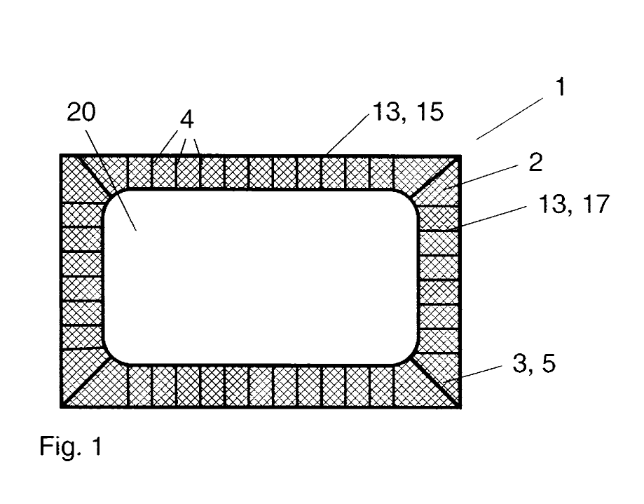

FIG. 1 is a schematic cross-sectional view of a cutout reinforcement according to the invention for a sandwich construction 1 according to a preferred embodiment of the invention. A braid core 1 which, in this preferred embodiment, is configured annularly and is made of foamed material, is surrounded by a braiding 5 with fibre strands 3. Furthermore, the braid core 2 has through holes 4 (in FIG. 1, some of these have been given reference numeral 4 by way of example) which extend through the braid core 2. Bundles of fibres 13 have been pulled into the through holes 4. The braid core 2 has an inner free region 20.

First of all, for this purpose the braid core 2 is formed from foamed material. In this exemplary embodiment, the braid core substantially has on the outside thereof a rectangular cross-sectional shape and has in the inner region 20 a more markedly rounded rectangular cross-sectional shape. Depending on the use, braid cores 2 can be configured with the most varied geometrical shapes, for example round or polygonal braid cores can be formed without the inner region 20. In the context of the present preferred embodiment, the braid core is then provided with through holes 4 by piercing. However, the through holes can also be produced by other methods, for example by drilling, water jet machining or laser beam machining. Fibre bundles 13 are then pulled through the through holes 4. In this respect, very varied sewing methods can be employed. In this preferred embodiment, the fibre bundles extend on the outside and in the inner region 20 of the braid core 2. Before or after being pulled into the braid core 2, the fibre bundles 13 can be provided with an adhesive 15, so that after the adhesive 15 has cured, the fibre bundles 13 are joined to the braid core 2 in a particularly firm manner, which produces a particularly stable bond of the cutout reinforcement according to the invention for a sandwich construction. Thereafter, the braid core 2 is braided 5 by fibre strands 3. Circular braiders are preferably used for this purpose. According to the preferred embodiment, the braid core 2 which is thus provided with the fibre bundles 13 and fibre strands 3 is then provided with a curable plastics material 17. This curable plastics material 17 preferably penetrates into the through holes 4 with the pulled-in fibre bundles 13 and, after curing, contributes to a fixing of the cutout reinforcement according to the invention for a sandwich construction 1.

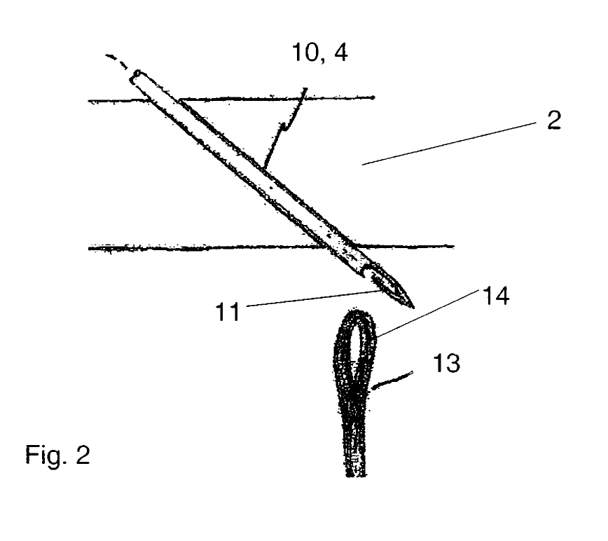

FIG. 2 is a schematic cross-sectional view of a stage of the method in which the needle 10 has penetrated the braid core 2. A fibre bundle 13 is shown under the needle 10. In this embodiment, the needle 10 has a hook 11. The fibre bundle 13 has a loop 14.

After the braid core 2 has been pierced, the loop 14 of the fibre bundle 13 is hooked into the hook 11 of the needle 10. When the needle 10 is pulled back, the fibre bundle 13 is pulled into the through hole 4 in the braid core 4. In this preferred embodiment, the needle 10 is joined to the fibre bundle 13 by hooking. Other methods of joining the needle 10 to the fibre bundle 13, for example adhesion, pinching and the like are also possible.

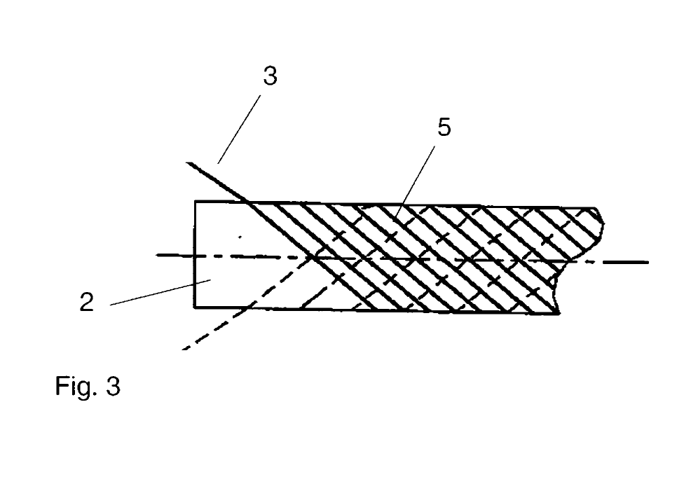

FIG. 3 is a schematic cross-sectional view of a braid core 2 in the braiding step of the method. The braiding 5 which is in the form of a net can be seen on the braid core 2. In the figure, the braid core 2 is braided with fibre strands 3 from right to left.

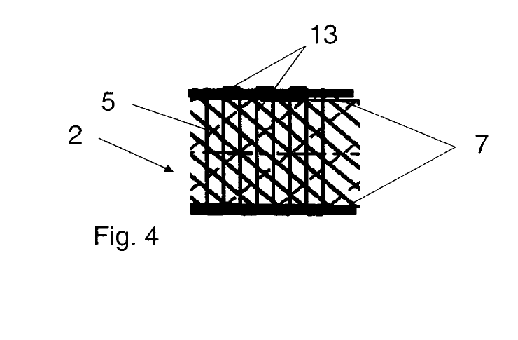

FIG. 4 is a cross-sectional view of a detail of a braid core which has been provided with cover layers 7. In this respect, the cover layers 7 have been sewn to the braid core 2 by means of the fibre bundles 13.

The cover layers 7 form a reinforcement of the braid core 2 which, in this embodiment, consists of foamed material and therefore has a low surface rigidity. The reinforcement 7 preferably consists of solid plastics materials.

Although the present invention has presently been described on the basis of preferred embodiments, it is not restricted thereto, but can be modified in many different ways.

According to the invention, to form a cutout reinforcement according to the invention for a sandwich construction, two methods are combined in order to improve the strength characteristics of a braid core which preferably consists of foamed material. For this purpose, a braiding is combined with fibre bundles pulled through holes in the braid core. Consequently, the cutout reinforcement according to the invention for a sandwich construction has particularly outstanding strength characteristics while the component has only a low weight.

The method according to the invention makes it possible for an opening to be provided even during production of the component, so that very stable cutouts are produced. The starting material is a ring of foamed material which has been reinforced with fibre bundles according to the method described above. However, the method can also be applied to pure foam parts which have not been reinforced. The internal contour has the dimensions of the subsequent cutout. This closed ring is introduced into a circular braider and braided discontinuously, thereby producing a closed fibre sheath. The preform thus sheathed with fibres is introduced into the core structure before the cover layers are applied and is then infiltrated together with the component. Alternatively, a pre-infiltrated component can also be produced. In order to avoid filling up the middle of the ring, a placeholder can be introduced which is removed after infiltration. Following infiltration, the cutout is ready for use, apart from a finishing operation which may be necessary. The fibre orientation can be adapted to the respective load. It is also possible to integrate stationary threads.

### LIST OF REFERENCE NUMERALS

1 cutout reinforcement for a sandwich construction
2 braid core
3 fibre strand (braiding)
4 through holes
5 braiding
7 cover layer
10 needle
11 hook
13 fibre bundles
14 loop
15 adhesive
17 curable plastics material
20 inner region of the braid core

1. A method for the production of a cutout reinforcement for a sandwich construction by a circular braiding method, wherein an annular braid core is braided with fibre strands and before or after braiding, through holes are produced in the braid core and one or more fibre bundles are pulled into the through holes in the braid core by a needle.

2. The method according to claim 1, wherein, when it is pulled in, the fibre bundle is hooked at least temporarily into the needle.

3. The method according to claim 1, wherein, when the fibre bundle is pulled in, the needle is substantially loaded in tension in an axial direction outside a hook.

4. The method according to claim 1, wherein a braid core consisting of foamed material is braided.

5. The method according to claim 1, wherein, before braiding, at least one cover layer which has a greater rigidity than the braid core is applied to the braid core.

6. The method according to claim 1, wherein the braid core is braided several times in succession.

7. The method according to claim 1, wherein the needle is also used to produce the through hole.

8. The method according to claim 1, wherein, shortly before or during the braiding procedure, an adhesive which has not yet cured during braiding is applied to the braid core or to the fibre strand.

9. The method according to claim 1, wherein, after the fibre bundles have been pulled into the through holes, said through holes and/or the braid core are infiltrated by a curable plastics material.

10. The method according to claim 1, wherein the fibre strands and the fibre bundles are joined together by reacting with one another chemically.

11. The method according to claim 1, wherein the inner region of the braid core is covered before infiltration.

12. A cutout reinforcement for a sandwich construction, which cutout reinforcement has an annular braid core, a braiding of the braid core and at least one hole through the annular braid core and at least one fibre bundles arranged in the through hole, the through hole having a cross-sectional area which is substantially completely filled by the at least one fibre bundle and the braiding also extending in an inner region of the annular braid core.

13. The cutout reinforcement according to claim 12, wherein the at least one fibre bundle has at least one loop.

14. The cutout reinforcement according to claim 12, wherein the fibre strands have carbon, glass, aramid and/or kevlar fibres.

15. The cutout reinforcement according to claim 12, wherein at least one cover layer of a greater rigidity than the braid core is arranged on the braid core.

16. The cutout reinforcement according to claim 12, wherein the fibre strands consist at least partly of Grilon threads.

17. The cutout reinforcement according to claim 12, wherein the fibre strands and the fibre bundles can be bonded together by a chemical reaction.
